(19) United States
(12) Patent Application Publication
(10) Pub. No.: US 2004/0059603 A1
(43) Pub. Date: Mar. 25, 2004

(54) System and method for virtual health services

(76) Inventors: Jacob Theodore Brown JR., Laurel, MD (US); Arthur F. Cooksey III, Laurel, MD (US); David A. Jones, Hunterville, NC (US)

Correspondence Address: MCKAY & ASSOCIATES, PC., 801 MCNEILLY ROAD, PITTSBURG, PA, 15226, US

(21) Appl. No.: 10/414,182

(22) Filed: Apr. 15, 2003

Related U.S. Application Data
(60) Provisional application No. 60/372,112, filed on Apr. 15, 2002.

(51) Int. Cl. G06F 17/60; G06F 7/00; G06F 17/00

(52) U.S. Cl. 705/2; 707/104.1

(57) ABSTRACT

A system and method for allowing health providers and patients to communicate from a remote location is disclosed. Health codes are provided to a health provider after the health provider registers with an online website. The code allows the provider access to a medical records database. A patient health code is further established, such that the patient is also allowed access to the medical records database, whereby an interactive communication means is provided for consultations and diagnoses regarding the records of the database.

### SPECIFIC REFERENCE

The present invention claims priority so established by provisional application serial No. 60/372,112, filed Apr. 15, 2002.

### BACKGROUND

The present invention relates generally to communication networks for health care providers. Particularly, a system and method is disclosed for providing a telecommunication-based network for facilitating the exchange of information between patient/clients, health care facilities, and health care providers.

Patient care and communication systems are generally known in the art. U.S. Pat. No. 5,822,544 to Chaco et al. teaches a patient care and communication system which utilizes a central processing system and a plurality of remote stations electrically connected to the central processing system to facilitate audio, visual and data communications. U.S. Pat. No. 6,449,001 to Levy et al. shows an assembly and process for video telecommunication between a host site and a remote site for medical applications. Furthermore, U.S. Pat. No. 5,544,649 to David et al. describes an ambulatory (in the home) patient health monitoring system wherein the patient is monitored by a health care worker at a central station, while the patient is at a remote location.

Having resources available as part of a health team increases the quality and quantity of health services in general, available to the communities. Health providers should be empowered with better access to information, education, training and consultation from specialists in all types of disorders, mental health and substance abuse. Particularly, every primary health care provider should be able to communicate with every other health care provider, health facility, and specialist necessary to provide the appropriate care in anticipation of global threats and attacks, including, for example, bio-terrorism.

The prospect of a bio-terrorist attack (i.e. small pox, anthrax, etc.) threatens to overwhelm an already fragile health care delivery system within the United States and worldwide. The community would be at a disadvantage because of (1) the number of people affected or infected, (2) the number of health care professionals available to treat infected persons, and (3) inefficient and unreliable communications between health providers and treatment facilities, and no uniform training and education for all health care providers. In addition to the primary health care problem associated with bio-terrorism, there may be an inordinate rise in the number of mental health and substance abuse problems in anticipation of, and in reaction to, a bio-terrorist attack. It is well documented that primary health care providers are not currently prepared to respond to these special problems which would become paramount as a result of a bio-terrorist attack, or even a significant threat thereof. Indeed, the anxiety, stress, depression and substance abuse problems associated with a bio terrorist threat can be equal to, or exceed, the medical problems associated with an actual event.

Thus, some of the more prominent concerns in the event of widespread health threats or attacks which would require input and exchange of information between specialists include, among others, a lack of an organized plan or model to respond to a multifaceted effect; a lack of facilities to accommodate the immense demand for treatment from the general population; being able to reach persons who are in remote, rural areas of who cannot physically travel to designated treatment facilities; and identifying resources that are cost effective and immediately available to establish a foundation for an alternative/supplemental emergency health care delivery system.

Accordingly, there is a need for a method and system for providing a virtual network capable of utilizing a primary care practitioner and technology to increase the availability and access to health services.

### SUMMARY OF THE INVENTION

A plurality of doctors and nurses are equipped with a virtual capability such that they will be able to text, talk, or see and talk to each other and patients via a network, no matter where they may be physically located. This may be accomplished using a virtual healthcare station generally comprising an input and output means, a webcam, an uninterruptible power supply, and a computer. All components are preferably mounted on an adjustable swivel stand and mount. Access to the internet is provided via a telephone line, DSL, T1, or other high speed connection. Client/patient computer and peripherals are appropriately equipped as further described.

Participating health facilities are provided with unique virtual service access codes. Facilities will have an intranet and internet, and a health communications network with DOD level encryption and firewall safeguards. Training topics and texts are incorporated into the software and presented by competent health professionals, or as a computerized character relaying scripted audio or video.

Thus it is an objective of the present invention to enable primary care physicians (PCP) to virtually communicate with one another and other specialists in real time using audio/video technology and thereby enable the PCP with the means for provisional and routine follow-up and evaluations.

It is further an objective of the present invention to allow for the rapid creation and dissemination of special training and information to health care providers and specialists to thereby create an organized and efficient communications network for health care providers.

It is further an objective of the present invention to increase the availability and access to mental health services and for the elderly, disabled, and persons living in remote, rural, and medical health shortage areas.

Accordingly, what is provided is a system and method for providing a virtual health network, comprising a medical records database of a patient residing on a remote server; a means for creating a provider virtual health code for allowing a health provider to access said medical records database upon an on-line registration with said server; a means for creating a patient virtual health code for allowing said patient to access said medical records database; and a means for allowing said provider and said patient to communicate with each other regarding said medical records database from a remote location.

### BRIEF DESCRIPTION OF THE DRAWINGS

FIG. 1 is a perspective view example of a virtual healthcare station.

FIG. 2 is a diagram of the networking system and production of the health codes.

FIG. 3 is a diagram of the networking system and medical records database.

FIG. 4 is a diagram of the networking system and associated communications relating to laboratory test results.

FIG. 5 is a diagram of the networking system and drug/prescription process.

The flow diagrams as presented herein represent applications that can be performed using a general-purpose computer programmed with software or as circuitry used by a specialized device. Accordingly, the steps represent software or logic flow that can be implemented in discrete programs or circuits.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated method, and such further applications of the principles of the invention illustrated herein, as would normally occur to persons skilled in the art to which the invention relates.

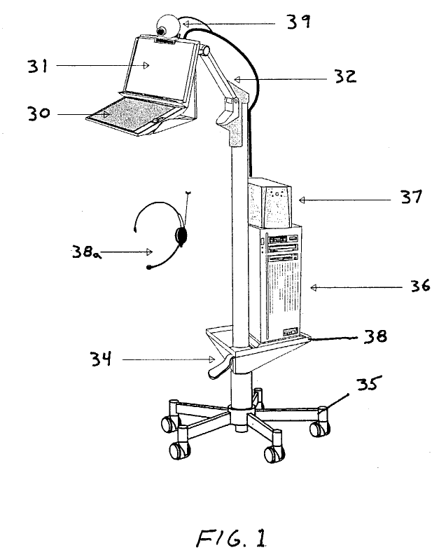

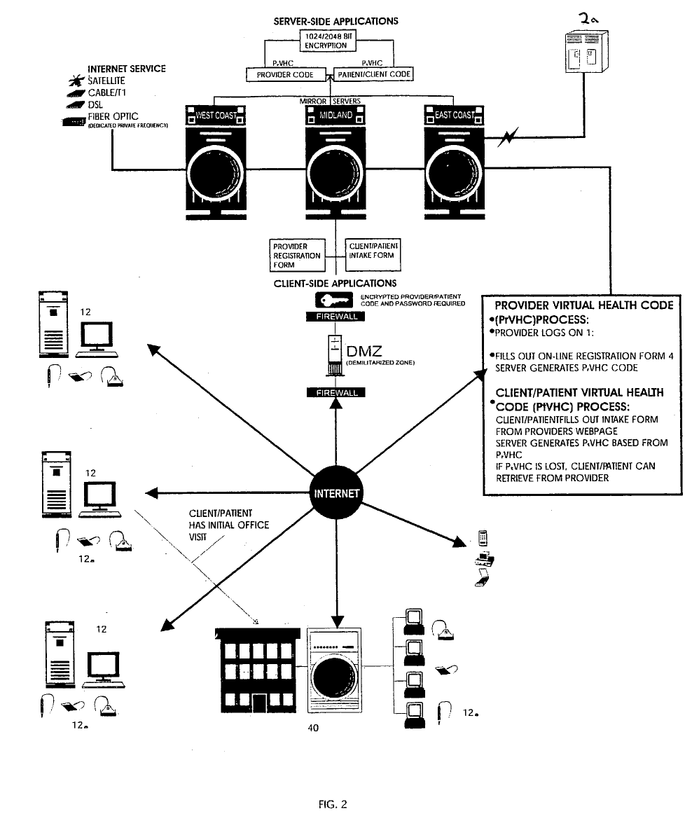

In relation to FIGS. 1-5, a health provider 1, via the internet 15, logs on to a website being hosted by a central server (or group of regional, mirror servers 2 powered by an uninterruptible power supply 2a). A provider virtual health code 3 is then created by the server when the provider fills out an on-line registration form 4. The provider virtual health code 3 will enable a provider to access a medical records database 50, resources, and the network, using his or her computer on their hospital or clinic local area network (LAN) 40.

The system is not limited as to the type of computer which may be used in accessing the network. As a general definition, the provider's computer 11 and the client/patient's computer 12 will typically comprise an input device such as a mouse and/or a keyboard, and a display device such as a monitor. It may also be any type of hand-held device 41. For security and authentication purposes, the hand-held device and/or computer should have IP addresses capable of being registered with the present system, similar to the registration of any provider as will be further described. The provider's computer could similarly include a dongle means attachable to the computer port as a security enhancement for authenticating any access into the system.

In the preferred embodiment, the computer must be capable of accessing the internet by any connection means, such as dial-up, DSL, cable/T1, ISDN, wireless, satellite or the like. The computer also generally comprises a random access memory (RAM), a read only memory (ROM), a central processing unit (CPU), and a storage device such as a hard disk drive or a floppy drive, and any other smartcards, readers, or other peripheral devices 12a.

An example of a mobile virtual health station that may be used to access the network either by the patient/client or health provider and which is capable of being registered is shown in FIG. 1. In this embodiment, the patient/client and provider will be able to hear, see, and talk to one another from remote locations. An input means 30 such as keyboard or touchpad is coupled to an output means 31 such as a display device. A webcam 39 is mounted to the output means 31 and both the input means 30 and output means 31 are preferably mounted to a swivel mount 32 upstanding from an adjustable stand 34. The stand 34 comprises a wheeled base-member 35 and a platform means 38 configured to allow a micro-processor-based CPU 36 and power supply 37 to rest thereon. Mobility in communication may further be enhanced by providing a wireless headset 38a.

The providers are allowed access to a medical records database 50. For access to the medical records database 50, the provider will enter an assigned website into the address bar as is generally known in the art. The provider will log in to their administrative section (virtual office) by input of their provider virtual health code 3. All transactions are logged and archived. The provider virtual health code 3 is created when the provider clicks on the link for registration on the main web page. The provider fills out a registration form, and from the following data input fields as shown in table 1, the code is generated:

TABLE 1

| | |
|---|---|
| Virtual provider code heading | VP |
| First, Middle Initial, Last | 5 digit randomly generated |
| Name | alphanumeric code |
| Professional category | 2 digit code (ex:02) |
| Specialty | 2 digit code (ex:Y3) |
| State or Province | 2 digit code (ex:Y3) |
| Country | 2 digit code (ex:US) |
| Example | VP 5T2B4 02 X1 Y3 US |

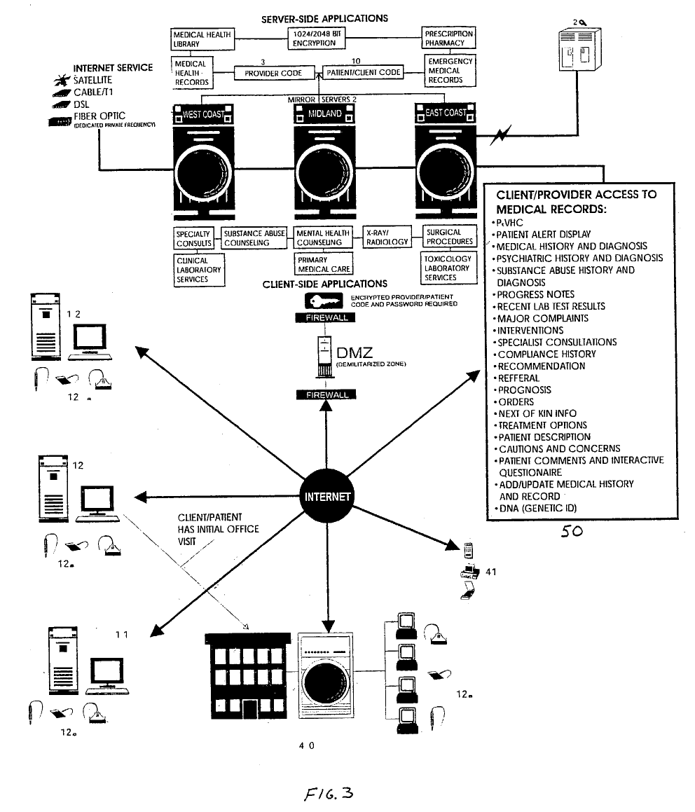

By allowing the provider access to a medical records database 50, they will have a menu of services to select from for any given patient, such as laboratory test results, prescriptions, substance abuse history, social services history, x-ray reports, etc.). Thus, the providers will obtain critical patient information quickly. An example listing of some of the accessible virtual patient medical records established in the virtual medical records (VMR) database 50 is shown in FIG. 3.

Furthermore, upon completion of an intake and registration form by a prospective patient, a patient virtual health code 10 is then created by the server(s) 2 in similar fashion as above such that the client contacts the associated website and fills out the registration form. Each patient virtual health code 10 is unique for every given patient, and each patient will preferably have only one primary care provider. Only the patient, the virtual primary care provider or consulting specialist and administrator will be able to associate a health code and the records of the virtual medical records database 50 with a patient's name. Thus, the established network structure and healthcare environment allows the patient access to comprehensive primary health care service specialist, emergency health care, international health care, information, training, education, consultation on a worldwide basis. They have the benefit of professional and peer support independent of where they may be physically located.

Since diagnostics are often an ongoing work in progress, the VMR database 50 is organized to capture, integrate and modify information immediately. After entering their “virtual office” from the main web page, the provider may choose the link associated with the data they need to enter for the respective category. If a provider needs to input/update data to a medical record, there is a form that has the required fields. This process allows for a means for the automatic and immediate creation or modification of a clinical diagnosis.

The VMR database 50 helps maintain the most current and accurate diagnosis protocol and status of the patient. The updates are reflected in progress notes, VMR Summaries and Health Alerts. The VMR database allows patients, as well as providers, access to their information using their respective virtual codes. In addition, a means is provided for the patient to be able to make entries into their medical records in the form of patient progress notes to facilitate communication and accuracy of diagnosis and treatment. The patient's progress notes are a valuable contribution to clinical diagnosis and management for the VMR database 50.

After a diagnosis is determined by the provider either actually or “virtually”, the VMR database 50 will automatically generate the most common treatment protocols associated with the diagnosis after the results and records are entered into the database. The patient's chart is automatically reviewed for any major points of conflict (i.e. adverse drug interactions) and alternative treatment options. The clinical information is extracted and correlated to appropriate diagnostic possibilities (i.e., patient complains of memory loss, confusion, and/or irritability, appears withdrawn and saddened; the VMR database 50 will be scanned for diagnostic possibilities associated with these symptoms (i.e., depression delirium, dementia) to facilitate a working diagnosis and treatment alternatives. Thus, if a prescription, treatment, or referral etc. is ordered, the server(s) 2 processes the data and compares the results/services to the database of the treatment center or pharmacist or the like. This will include the most common prescriptions as well as alternative medical or health care interventions. A list of references is generated for the Provider (i.e., Journal Articles, Research Reports, Training Resources, etc) that may be needed to enhance their knowledge of current treatment methods.

The patient will also receive references and referrals to information and educational resources relevant to their particular diagnosis. Providers will receive a list of specialists associated with the diagnosis. Patients will also have access to this list of specialists. In addition, the Patient will be referred to training and chat sessions on the diagnosis. An ongoing menu of seminars and training sessions on a variety of health care topics is made available on line.

Laboratory specimen(s) are obtained by having the patient provide the specimen to a laboratory technician, nurse, etc. at home, the doctor's office, hospital, or having it picked up by express or overnight delivery to the laboratory. One such system for specimen collection and shipping means that may be used for this step is taught by U.S. Pat. No. 4,949,840 to Brown, the entire disclosure of which is herein incorporated by reference.

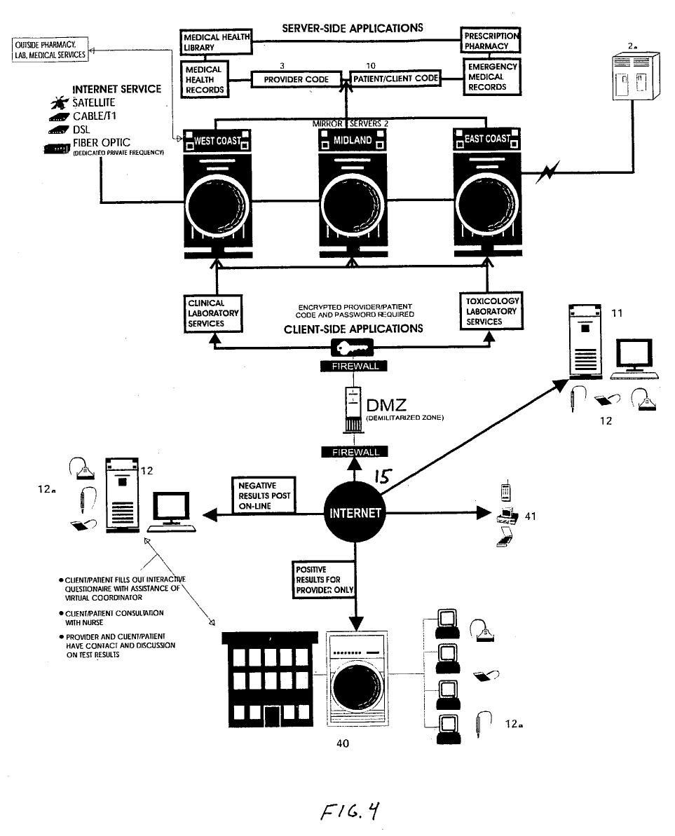

With the exception of special tests and conditions, the request for laboratory service should be ordered by a health care provider or physician. This request may be by mail, fax, phone, or e-mail. Only the patient virtual health code 10 will be used to identify specimens and results. As demonstrated by FIG. 4, if test results are negative, they will immediately be posted online. If test results are positive, the provider will be immediately notified. If notified by email, the e-mail can automatically transfer into a phone call to the provider. This is accomplished by associating the phone number with the email address as the information goes into a data field such that an alert may be automatically generated and a phone number automatically dialed. In this manner, a script is translated into voice (audio), similar to the use of a computerized character or cartoon figure designed to relay this information. The provider will then be able to access test results via their provider virtual health codes 3. Providers are able to review Patient's Medical History (i.e., lab results, clinical history, medications, etc.) to help interpret test results and reach a provisional or working diagnosis. Based upon the diagnosis, a proposed plan of treatment, medications, information, education, training, and specialists, will be generated for the provider and the patient.

The patient will be encouraged to complete an Interactive Patient Questionnaire (IPQ) prior to conferring with the provider. They are assisted through this process by a virtual coordinator or nurse. The provider will then review the Patient's response to items on the IPQ, and then schedule an appointment to communicate with the patient in person, over the phone or virtually via e-mail or audio/visually. Provider and patient will agree upon a course of action and then proceed accordingly. All pertinent information will be captured and entered into the virtual medical record database 50. The Patient will also have access via their patient virtual health code 10 to their full medical chart.

The fact that only identification numbers and not names are used is critical to maintaining confidentiality. Furthermore, the availability of laboratory test results via the communication between all databases is also an extremely valuable and unique health care feature. It can greatly facilitate health care for a patient irrespective of where they may be physically located.

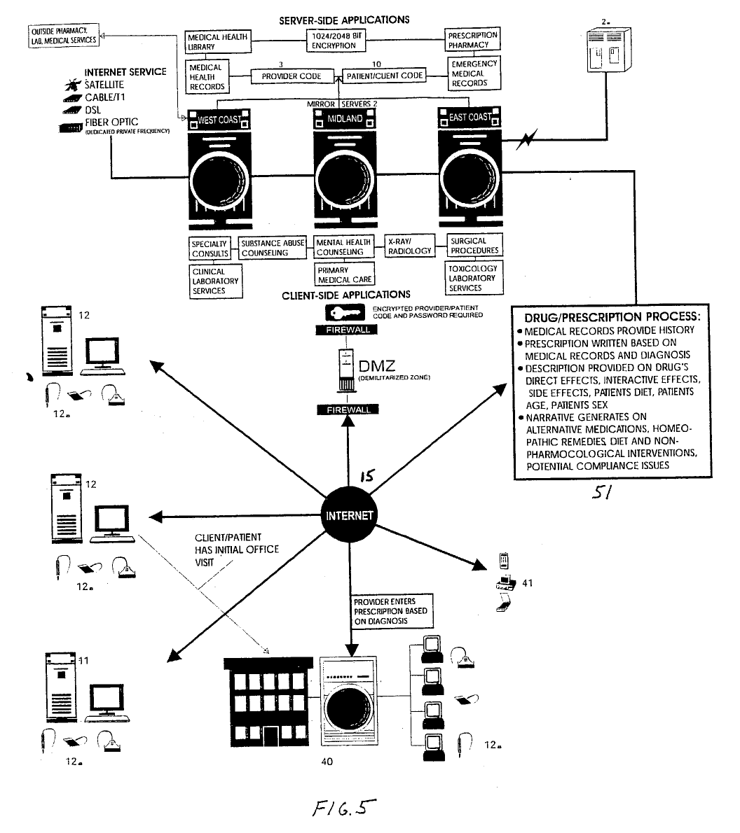

With reference to FIG. 5, a pharmacy protocol 51 is generated based on data obtained from the VMR database 50 after the ultimate diagnosis by the provider. In this prescription process, a description is provided on the drug's effects and a narrative will be automatically generated with each prescription describing that effect and any alternative interventions. Accordingly, and as should be understood in relation to those of ordinary skill with reference to this specification, the patient can order their medication online and have it delivered directly to their home in conjunction with their virtual communications with the provider.

I claim:

1. A system for providing a virtual health network, comprising:
a medical records database of a patient residing on a remote server;
a means for creating a provider virtual health code for allowing a health provider to access said medical records database upon an on-line registration with said server;
a means for creating a patient virtual health code for allowing said patient to access said medical records database; and
a means for allowing said provider and said patient to communicate with each other regarding said medical records database from a remote location.
